(19) United States
(12) Patent Application Publication
(10) Pub. No.: US 2005/0119920 A1
(43) Pub. Date: Jun. 2, 2005

(54) Method and apparatus for automated insurance processing

(76) Inventors: Patrick J. Murphy, Dublin, OH (US); John Fetherolf, Carroll, OH (US)

Correspondence Address: COUDERT BROTHERS LLP, 23RD FLOOR, 333 SOUTH HOPE STREET, LOS ANGELES, CA, 90071, US

(21) Appl. No.: 10/918,022

(22) Filed: Aug. 12, 2004

Related U.S. Application Data
(60) Provisional application No. 60/494,689, filed on Aug. 13, 2003.

(51) Int. Cl. G06F 17/60

(52) U.S. Cl. 705/4

(57) ABSTRACT

In one embodiment of the present invention, information about a customer is entered into an electronic system. In one embodiment, the customer is part of a low-margin market. In one embodiment, the customer's medical record comprises the customer's pharmaceutical records. In one embodiment, additional information (e.g., MIB, MVR, and/or Rx) is automatically requested about the customer from electronic databases using the information entered into the system about the customer. In one embodiment, information about a customer is scored. In another embodiment, certain information conditions are flagged. In one embodiment, if the customer meets the criteria for automatic policy approval, a policy is automatically issued for the customer. In one embodiment, if the customer meets the criteria for automatic policy denial, the customer is automatically denied a policy. In one embodiment, when certain customer information is entered, the customer's information is automatically sent to a human for review.

### RELATED APPLICATION INFORMATION

This application claims the benefit of U.S. Provisional Patent Application Ser. No. 60/494,689, filed Aug. 13, 2003, entitled, “Method and Apparatus for Automated Insurance Processing,” the disclosure of which is hereby incorporated by reference.

### BACKGROUND OF THE INVENTION

1. Field of the Invention

The present invention relates to the field of insurance issuing, and in particular to a method and apparatus for automated insurance processing.

2. Background Art

In the typical insurance buying process, a customer fills out a form which is transmitted in paper form to members of an insurance company that determine whether the insurance can be issued. In some systems, the customer can fill out a form online (e.g., via the world wide web). However, the online form is still printed out and sent to a person who makes the determination of whether to issue a policy or not. Thus, even healthy customers who desire immediate coverage (e.g., for life insurance) who engage in no risky behavior must wait days before knowing whether they are insured.

Alternatively, an insurer could issue insurance to everyone regardless of the risk involved. However, the premium would be much higher for non-risky customers, and thus, those customers would likely seek out other insurers. The above delays, difficulties and inefficiencies cause some portions of the potential insurance market (e.g., the middle market) to have a very low or even negative rate of return on investment of time, effort and capital of insurers or reinsurers.

### SUMMARY OF THE INVENTION

Embodiments of the present invention are directed to a method and apparatus for automated insurance processing. In one embodiment of the present invention, information about a customer is entered into an electronic system. In one embodiment, the customer (due to the customer's traits, desired insurance/reinsurance product, or other factors) is part of a low-margin market. A low-margin market is a portion of the insurance (or reinsurance) market wherein the expected profit from insuring (reinsuring) an entity within that portion is small relative to the cost of insuring an entity within that portion (e.g., payout expectations, overhead involved in developing business with the entity, etc.). Hereinafter “insurance” and “reinsurance” and related terms will be used interchangeably unless specifically indicated otherwise.

In one embodiment, the customer enters the information. In another embodiment, an insurance agent enters the information. In still another embodiment, the information is entered by a third party that is privy to the information (e.g., a bank, credit card company, retail sales store, club, fraternal organization, social organization, charitable society, etc.). In one embodiment, the information is entered via the world wide web. In one embodiment, the information is entered using a standardized XML format. In another embodiment, the information is entered as part of a batch of information entered about several individuals. In still another embodiment, the information is entered via the Internet. In one embodiment, the information gathered about the customer is done in stages. For example, at a first stage, a customer is asked for a certain set of information. Then, the information requested at a second stage is determined at least in part from information entered at a first stage. In one embodiment, part of the information entered is the customer's signature. In one embodiment, the signature is an electronic signature.

In one embodiment, information about a customer is used to automatically retrieve additional information. In one embodiment, information about a customer (e.g., the customer's name and/or social security number) is used to retrieve a customer's driving record. In another embodiment, information about a customer is used to retrieve a customer's medical record. In one embodiment, the customer's medical record comprises the customer's pharmaceutical records.

In one environment, information about the customer is entered anonymously at a facility where some of the information is generated. In an example embodiment, when a customer visits a physician, the customer's medical information and other relevant information are entered anonymously and the customer is presented with a tentative quote. If the customer wishes to proceed, additional information (e.g., the customer's identity) is entered and/or collected to produce a final quote. In this way, the customer can avoid additional trips to the physician and can be prompted with insurance options available to the customer at the customer's already scheduled visit. In another embodiment, the customer's information is entered by a medical testing facility that is performing medical tests upon the customer.

In one embodiment, additional information (e.g., MIB, MVR, and/or Rx) is automatically requested about the customer from electronic databases using the information entered into the system about the customer. In one embodiment, information about a customer is scored. In one embodiment, how different medications that are in the customer's pharmaceutical records interact with each other and/or commonly used medications, foods, and/or beverages. In another embodiment, certain information conditions are flagged (e.g., the customer is a smoker, has a fatal disease, takes medication taken for a fatal disease or disease related to risky behavior, hang-glides, flies airplanes, works with explosives, is an alcoholic, has been treated for a drug addiction, etc.).

In one embodiment, the information about the customer is used to determine whether the customer meets the criteria for automatic policy approval. If the customer meets the criteria for automatic policy approval, a policy is automatically issued for the customer. In one embodiment, the policy is automatically delivered to the customer electronically. In another embodiment, the policy is automatically sent to the customer in a paper format (e.g., the policy is automatically printed, enveloped and placed into a mail system). In one embodiment, the customer receives an offered rate based upon the information entered about the customer.

In one embodiment, the customer's information is submitted by an online service (e.g., online banking) used by the customer. When the customer logs into the online service, the customer is notified of the offered insurance product and rate. In one embodiment, by submitting the electronic application, the customer is agreeing to the offered rate. In another embodiment, if additional information collected about a customer alters the offered rate, the customer is automatically notified of the new rate (e.g., via e-mail, web site, automated phone call, etc). In one embodiment, the customer must agree to the new rate, if any, before a policy can issue. In another embodiment, if the new rate is lower, the customer's submission at the old rate constitutes acceptance at the lower rate as well.

In one embodiment, the information about the customer is used to determine whether the customer meets the criteria for automatic policy denial. If the customer meets the criteria for automatic policy denial, the customer is automatically denied a policy. In one embodiment, the customer's information is compared to more than one insurer's approval/denial criteria. In one embodiment, two entities (e.g., an insurer and a re-insurer) partition financial obligations with regard to a policy issued automatically. In one embodiment, when certain customer information is entered (e.g., one of a range of scores or one or more flags are associated with the customer information), the customer's information is automatically sent to a human for review. The human can review the information and request additional information from the customer and/or electronic databases or issue or deny a policy.

### BRIEF DESCRIPTION OF THE DRAWINGS

These and other features, aspects and advantages of the present invention will become better understood with regard to the following description, appended claims and accompanying drawings where:

FIG. 1 is a flow diagram of the process of insuring a customer who is part of a low-margin market in accordance with one non-limiting embodiment of the present invention.

FIG. 2 is a flow diagram of the process of insuring a customer who is part of the middle market in accordance with one non-limiting embodiment of the present invention.

FIG. 3 is a flow diagram of the process of insuring a customer who enters at least some of his or her information and who is part of a low-margin market in accordance with one non-limiting embodiment of the present invention.

FIG. 4 is a flow diagram of the process of insuring a customer who is part of a low-margin market wherein an insurance agent enters at least some of the customer information in accordance with one non-limiting embodiment of the present invention.

FIG. 5 is a flow diagram of the process of insuring a customer who is part of a low-margin market wherein at least some of the customer's information is entered by a third party in accordance with one non-limiting embodiment of the present invention.

FIG. 6 is a flow diagram of the process of insuring a customer, who is part of a low-margin market, using a computer network in accordance with one non-limiting embodiment of the present invention.

FIG. 7 is a flow diagram of the process of gathering information about potential customers within a low-margin market in accordance with one non-limiting embodiment of the present invention.

FIG. 8 is a flow diagram of a drill-down information entry process in accordance with one non-limiting embodiment of the present invention.

FIG. 9 is a flow diagram of the process of automatically retrieving additional information about a customer who is part of a low-margin market in accordance with one non-limiting embodiment of the present invention.

FIG. 10 is a flow diagram of the process of initiating customer information gathering at a traditionally slow part (preferably the slowest part) of the insurance application information gathering process in accordance with one non-limiting embodiment of the present invention.

FIG. 11 is a flow diagram of the process of automatically insuring a customer in a low-margin market in accordance with one non-limiting embodiment of the present invention.

FIG. 12 is a block diagram of a general purpose computer.

### DETAILED DESCRIPTION OF THE INVENTION

The invention is a method and apparatus for automated insurance processing. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Various embodiments of the invention may be used with the systems and methods described in U.S. patent application Ser. No. 09/986,204, filed Nov. 7, 2001, entitled, “System and Method for Enabling Real Time Underwriting of Insurance Policies;” U.S. patent application Ser. No. 09/993,153, filed Nov. 6, 2001, entitled, “Automated Insurance Policy Application;” and U.S. patent application Ser. No. 09/883,193, filed Jun. 19, 2001, entitled, “System and Method for Facilitating Interaction with a Financial Service,” the disclosures of which are hereby incorporated by reference.

Electronic Insurance in Low-Margin Markets

In one embodiment of the present invention, information about a customer is entered into an electronic system. In one embodiment, the customer (due to the customer's traits, desired insurance/reinsurance product, or other factors) is part of a low-margin market (e.g., the middle market). A low-margin market is a portion of the insurance (or reinsurance) market wherein the expected profit from insuring (reinsuring) an entity within that portion is small relative to the cost of insuring an entity within that portion (e.g., payout expectations, overhead involved in developing business with the entity, etc.).

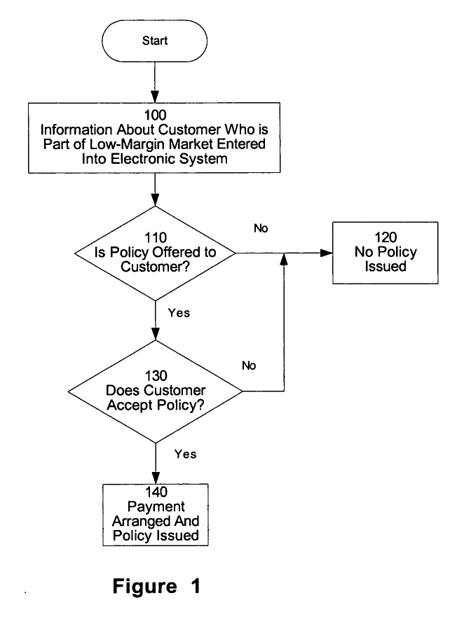

FIG. 1 illustrates the process of insuring a customer who is part of a low-margin market in accordance with one non-limiting embodiment of the present invention. At block 100, information about a customer who is part of a low-margin market is entered into an electronic system. At block 110, it is determined whether to offer a policy to the customer. If a policy is not offered to the customer, at block 120, no policy is issued. If a policy is offered to the customer, at block 130, it is determined whether the customer accepts the policy. If the customer does not accept the policy, the process continues to block 120. If the customer accepts the policy, at block 140, payment is arranged and the policy is issued.

In one embodiment, the customer is part of a middle market for life insurance. The middle market for life insurance comprises life insurance policies with insurance amounts in the range of approximately $50,000 to approximately $250,000 in 2003 dollars. For example, a credit union may offer life insurance policies with insurance amounts in the middle market range to each of its members in accordance with one embodiment of the present invention.

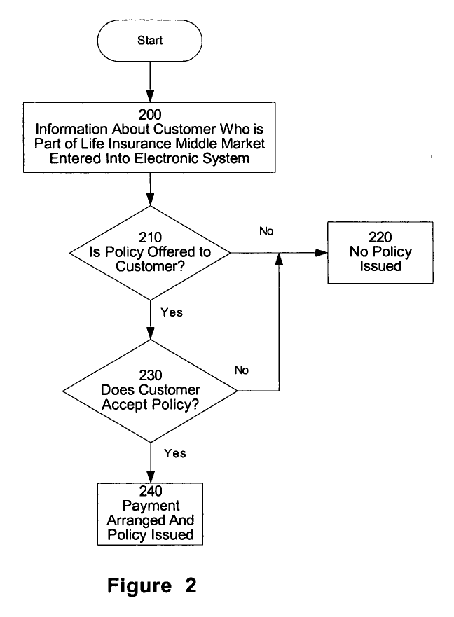

FIG. 2 illustrates the process of insuring a customer who is part of the middle market in accordance with one non-limiting embodiment of the present invention. At block 200, information about a customer who is part of the life insurance middle market is entered into an electronic system. At block 210, it is determined whether to offer a policy to the customer. If a policy is not offered to the customer, at block 220, no policy is issued. If a policy is offered to the customer, at block 230, it is determined whether the customer accepts the policy. If the customer does not accept the policy, the process continues to block 220. If the customer accepts the policy, at block 240, payment is arranged and the policy is issued.

Entering Customer Information

In one embodiment, the customer enters the information. In another embodiment, an insurance agent enters the information. In still another embodiment, the information is entered by a third party that is privy to the information (e.g., a bank, credit card company, retail sales store, club, fraternal organization, social organization, charitable society, doctor's office, medical insurance company, etc.).

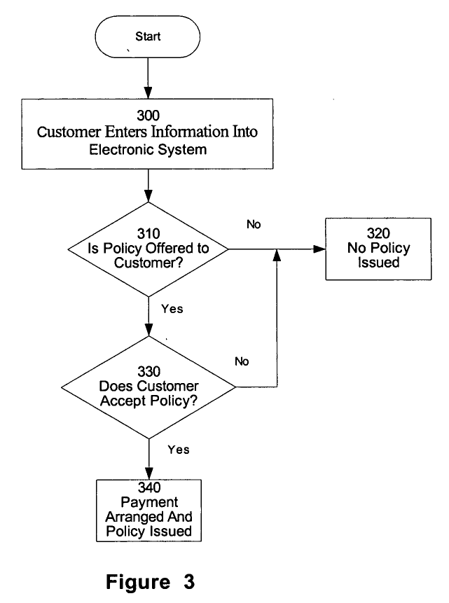

FIG. 3 illustrates the process of insuring a customer who enters at least some of his or her information and who is part of a low-margin market in accordance with one non-limiting embodiment of the present invention. At block 300, the customer, who is part of a low-margin market, enters information about himself or herself into an electronic system. At block 310, it is determined whether to offer a policy to the customer. If a policy is not offered to the customer, at block 320, no policy is issued. If a policy is offered to the customer, at block 330, it is determined whether the customer accepts the policy. If the customer does not accept the policy, the process continues to block 320. If the customer accepts the policy, at block 340, payment is arranged and the policy is issued.

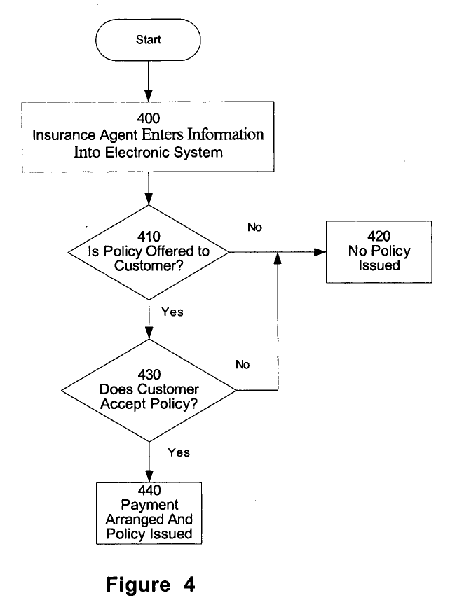

FIG. 4 illustrates the process of insuring a customer who is part of a low-margin market wherein an insurance agent enters at least some of the customer information in accordance with one non-limiting embodiment of the present invention. At block 400, an insurance agent enters information about the customer, who is part of a low-margin market, into an electronic system. At block 410, it is determined whether to offer a policy to the customer. If a policy is not offered to the customer, at block 420, no policy is issued. If a policy is offered to the customer, at block 430, it is determined whether the customer accepts the policy. If the customer does not accept the policy, the process continues to block 420. If the customer accepts the policy, at block 440, payment is arranged and the policy is issued.

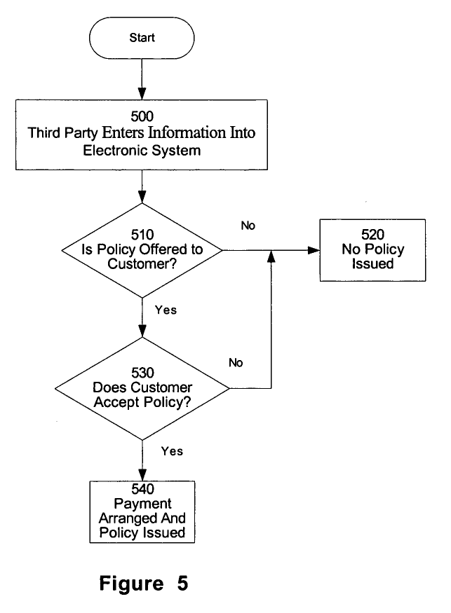

FIG. 5 illustrates the process of insuring a customer who is part of a low-margin market wherein at least some of the customer's information is entered by a third party in accordance with one non-limiting embodiment of the present invention. At block 500, a third party with information about the customer (e.g., the issuer of a store credit card account of the customer's, the customer's physician, a society to which the customer belongs, etc.) enters information about the customer, who is part of a low-margin market, into an electronic system. At block 510, it is determined whether to offer a policy to the customer. If a policy is not offered to the customer, at block 520, no policy is issued. If a policy is offered to the customer, at block 530, it is determined whether the customer accepts the policy. If the customer does not accept the policy, the process continues to block 520. If the customer accepts the policy, at block 540, payment is arranged and the policy is issued.

In one embodiment, the information is entered via the world wide web. In one embodiment, the information is entered using a standardized XML format. In other embodiments, other data formats and protocols are used. In another embodiment, the information is entered via the Internet. In still another embodiment, the information is entered via a private network. In yet another embodiment, the information is entered via a dedicated network used for insurance purposes only.

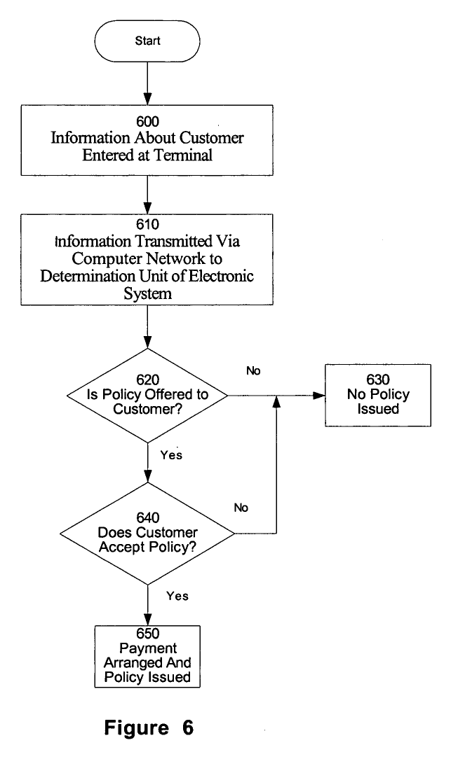

FIG. 6 illustrates the process of insuring a customer, who is part of a low-margin market, using a computer network in accordance with one non-limiting embodiment of the present invention. At block 600, information about a customer who is part of a low-margin market is entered at a terminal. The terminal may be a general purpose computer, a PDA, a cell phone or any other system capable of inputting the data and connecting to the network. At block 610, the information is transmitted via a computer network to a determination unit of an electronic system. At block 620, it is determined whether to offer a policy to the customer. If a policy is not offered to the customer, at block 630, no policy is issued. If a policy is offered to the customer, at block 640, it is determined whether the customer accepts the policy. If the customer does not accept the policy, the process continues to block 630. If the customer accepts the policy, at block 650, payment is arranged and the policy is issued.

In another embodiment, the information is entered as part of a batch of information entered about several individuals. In one embodiment, information is entered by retrieving the information from a database in which the information is already stored. In one embodiment, an automated process searches a database for potential customers that are part of a low-margin market. Information about those potential customers is automatically formatted and entered.

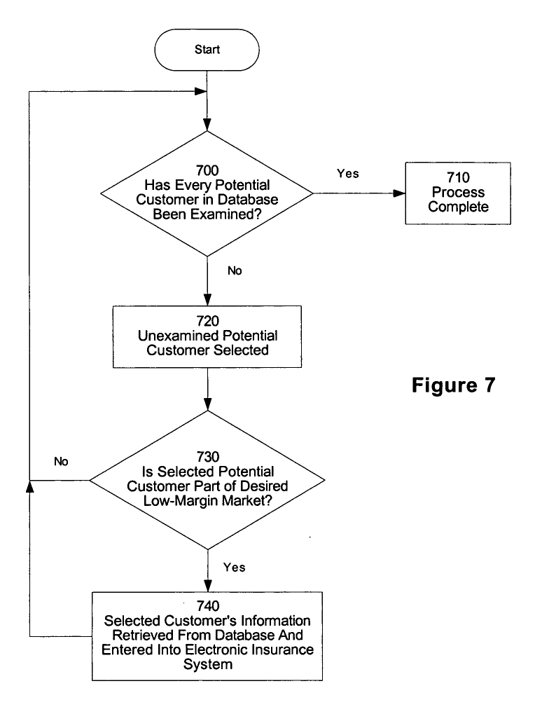

FIG. 7 illustrates the process of gathering information about potential customers within a low-margin market in accordance with one non-limiting embodiment of the present invention. At block 700, it is determined whether every potential customer in a database has been examined. If every potential customer in a database has been examined, at block 710, the process is complete. If not every potential customer in a database has been examined, at block 720, an unexamined potential customer is selected. At block 730, it is determined whether the selected potential customer is part of the desired low-margin market. If the selected potential customer is not part of the desired low-margin market, the process repeats at block 700. If the selected potential customer is part of the desired low-margin market, at block 740, the selected customer's information is retrieved from the database and entered into an electronic insurance system, and the process repeats at block 700.

In alternative embodiments, variations on the process illustrated in FIG. 7 are used. In an example embodiment, information about all customers that are part of a desired low-margin market is stored and entered into the electronic insurance system in one or more bundles of data. In another example embodiment, there is more than one desired low-margin market.

Drill-Down Customer Information Gathering

In one embodiment, the information gathered about the customer is done in stages. For example, at a first stage, a customer is asked for a certain set of information. Then, the information requested at a second stage is determined at least in part from information entered at a first stage. In one embodiment, part of the information entered is the customer's signature. In one embodiment, the signature is an electronic signature.

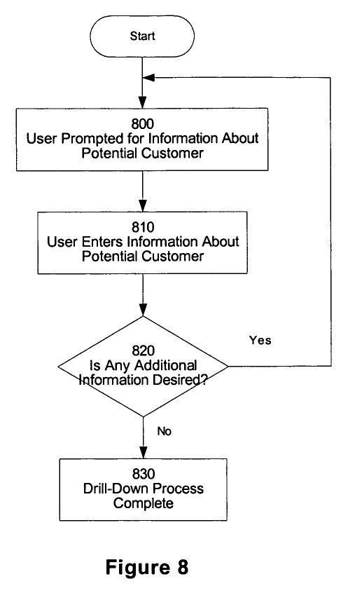

FIG. 8 illustrates a drill-down information entry process in accordance with one non-limiting embodiment of the present invention. At block 800, a user is prompted for information about a potential customer. A user may be the potential customer, an insurance agent, a third party, or an automated computer process (i.e., a script or program). At block 810, the user enters information about the potential customer. At block 820, it is determined from any of the information entered at block 810 whether any additional information is desired. For example, if a user enters that the potential customer has a heart problem, at 820 it may be determined that more specific information about the potential customer's heart health is required. If no additional information is desired, at block 830, the drill-down process is complete. If additional information is desired, the process repeats at block 800.

Automatic Retrieval of Additional Customer Information

In one embodiment, information about a customer is used to automatically retrieve additional information. In one embodiment, information about a customer (e.g., the customer's name and/or social security number) is used to retrieve a customer's driving record. In another embodiment, information about a customer is used to retrieve a customer's medical record. In one embodiment, the customer's medical record comprises the customer's pharmaceutical records.

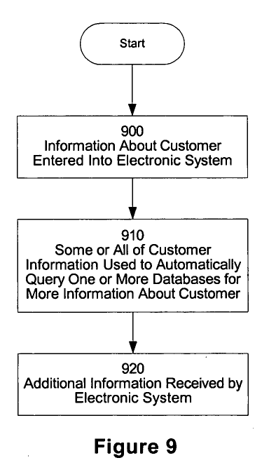

FIG. 9 illustrates the process of automatically retrieving additional information about a customer who is part of a low-margin market in accordance with one non-limiting embodiment of the present invention. At block 900, information about a customer who is part of a low-margin market is entered into an electronic system. At block 910, some or all of the customer information (e.g., name, social security number, driver's license number, etc.) is used to automatically query one or more databases for more information about the customer. The queried database may be a government agency database (e.g., a state department of motor vehicles database) or any other database (e.g., Medical Insurance Bureau—MIB, prescription database—Rx, individual insurance company database, sex offender database, criminal records database, etc.) At block 920, the additional information is received by the electronic system.

Efficient and/or Opportunistic Potential Client Information Gathering

In one embodiment, information about the customer is entered anonymously at a facility where some of the information is generated. In one embodiment, the information is gathered at the facility that takes the most time to collect information in traditional insurance application information gathering processes (e.g., a doctor's office). In an example embodiment, when a customer visits a physician, the customer's medical information and other relevant information are entered anonymously and the customer is presented with a tentative quote. If the customer wishes to proceed, additional information (e.g., the customer's identity) is entered and/or collected to produce a final quote. In this way, the customer can avoid additional trips to the physician and can be prompted with insurance options available to the customer at the customer's already scheduled visit. In another embodiment, the customer's information is entered by a medical testing facility that is performing medical tests upon the customer.

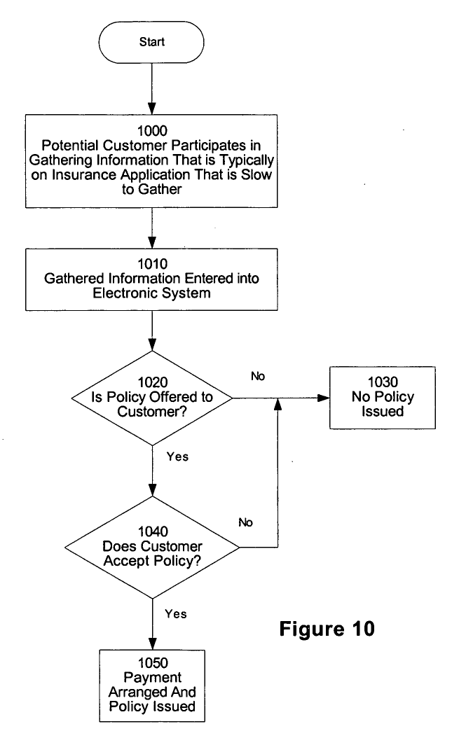

FIG. 10 illustrates the process of initiating customer information gathering at a traditionally slow part (preferably the slowest part) of the insurance application information gathering process in accordance with one non-limiting embodiment of the present invention. At block 1000, a potential customer who is part of a low-margin market and who may or may not intend to investigate his or her insurance options participates in gathering information that is typically information on an insurance application that is slow (or slowest) to gather. In an example embodiment, a potential customer visits a physician for an annual check-up, has various medical tests (including laboratory tests) performed, and contacts the physician to discuss the results of the tests.

At block 1010, the gathered information is entered into an electronic system. At block 1020, it is determined whether to offer a policy to the customer. If a policy is not offered to the customer, at block 1030, no policy is issued. If a policy is offered to the customer, at block 1040, it is determined whether the customer accepts the policy. If the customer does not accept the policy, the process continues to block 1030. If the customer accepts the policy, at block 1050, payment is arranged and the policy is issued.

Determining Policy Issuance Using Scoring

In one embodiment, additional information (e.g., MIB, Motor Vehicle Records—MVR, and/or Rx) is automatically requested about the customer from electronic databases using the information entered into the system about the customer. In one embodiment, information about a customer is scored. In one embodiment, how different medications that are in the customer's pharmaceutical records interact with each other and/or commonly used medications, foods, and/or beverages. In another embodiment, certain information conditions are flagged (e.g., the customer is a smoker, has a fatal disease, takes medication taken for a fatal disease or disease related to risky behavior, hang-glides, flies airplanes, works with explosives, is an alcoholic, has been treated for a drug addiction, etc.).

In one embodiment, the information about the customer is used to determine whether the customer meets the criteria for automatic policy approval. If the customer meets the criteria for automatic policy approval, a policy is automatically issued for the customer. In one embodiment, the policy is automatically delivered to the customer electronically. In another embodiment, the policy is automatically sent to the customer in a paper format (e.g., the policy is automatically printed, enveloped and placed into a mail system). In one embodiment, the customer receives an offered rate based upon the information entered about the customer.

In one embodiment, the customer's information is submitted by an online service (e.g., online banking) used by the customer. When the customer logs into the online service, the customer is notified of the offered insurance product and rate. In one embodiment, by submitting the electronic application, the customer is agreeing to the offered rate. In another embodiment, if additional information collected about a customer alters the offered rate, the customer is automatically notified of the new rate (e.g., via e-mail, web site, automated phone call, etc). In one embodiment, the customer must agree to the new rate, if any, before a policy can issue. In another embodiment, if the new rate is lower, the customer's submission at the old rate constitutes acceptance at the lower rate as well.

In one embodiment, the information about the customer is used to determine whether the customer meets the criteria for automatic policy denial. If the customer meets the criteria for automatic policy denial, the customer is automatically denied a policy. In one embodiment, the customer's information is compared to more than one insurer's approval/denial criteria. In one embodiment, two entities (e.g., an insurer and a re-insurer) partition financial obligations with regard to a policy issued automatically. In one embodiment, when certain customer information is entered (e.g., one of a range of scores or one or more flags are associated with the customer information), the customer's information is automatically sent to a human for review. The human can review the information and request additional information from the customer and/or electronic databases or issue or deny a policy.

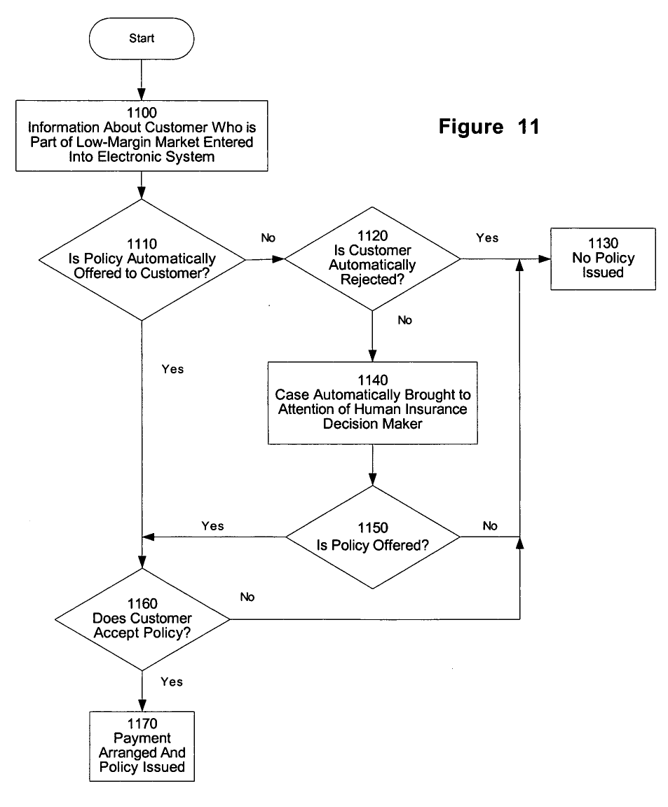

FIG. 11 illustrates the process of automatically insuring a customer in a low-margin market in accordance with one non-limiting embodiment of the present invention. At block 1100, information about a customer who is part of a low-margin market is entered into an electronic system. The customer may be aware or unaware that his or her information is being entered. At block 1110, it is determined using a scoring system based upon information collected about the customer whether to automatically offer a policy to the customer. If a policy is not automatically offered to the customer, at block 1120, it is determined using a scoring system based upon information collected about the customer whether to automatically reject the customer.

If the customer is automatically rejected, at block 1130, no policy is issued. If the customer is not automatically rejected, at block 1140, the case is automatically brought to the attention of a human insurance decision maker. At block 1150, the human insurance maker decides whether to issue a policy. If a policy is not offered, the process continues at block 1130. If a policy is offered automatically or by the human decision maker, at block 1160, it is determined whether the customer accepts the policy. If the customer does not accept the policy, the process continues at block 1130. If the customer accepts the policy, at block 1170, payment is arranged and the policy is issued.

### Embodiment of Computer Execution Environment (Hardware)

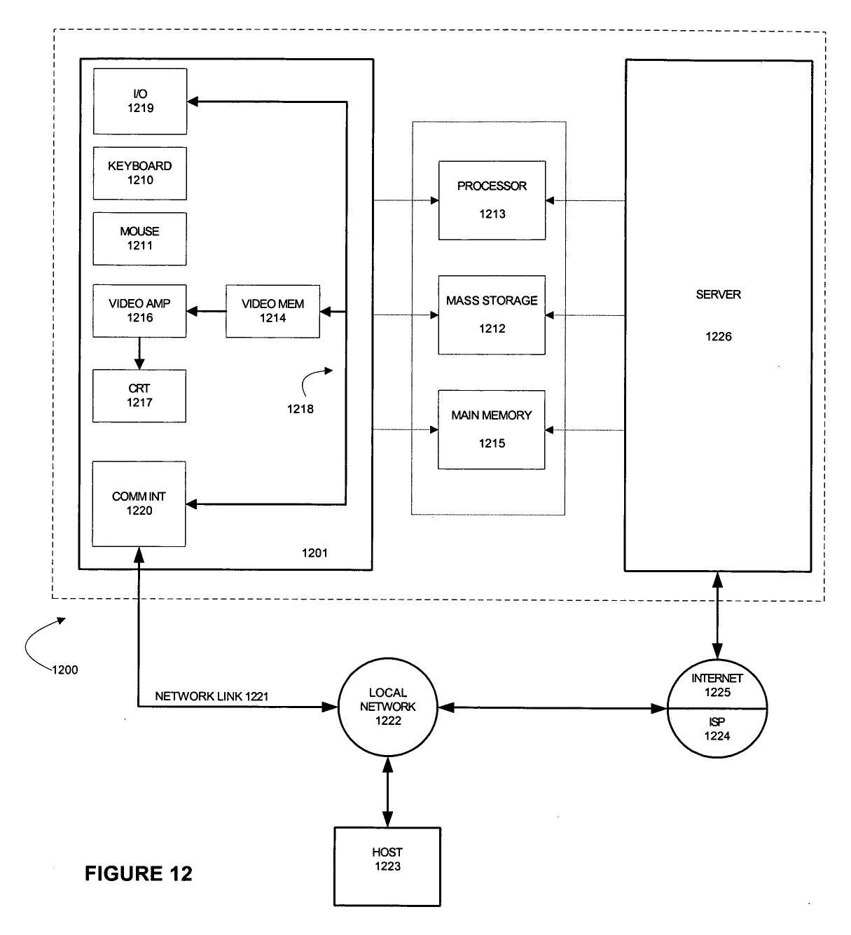

An embodiment of the invention can be implemented as computer software in the form of computer readable program code executed in a general purpose computing environment such as environment 1200 illustrated in FIG. 12. A keyboard 1210 and mouse 1211 are coupled to a system bus 1218. The keyboard and mouse are for introducing user input to the computer system and communicating that user input to central processing unit (CPU) 1213. Other suitable input devices may be used in addition to, or in place of, the mouse 1211 and keyboard 1210. I/O (input/output) unit 1219 coupled to bidirectional system bus 1218 represents such I/O elements as a printer, A/V (audio/video) I/O, etc.

Computer 1201 may include a communication interface 1220 coupled to bus 1218. Communication interface 1220 provides a two-way data communication coupling via a network link 1221 to a local network 1222. For example, if communication interface 1220 is an integrated services digital network (ISDN) card or a modem, communication interface 1220 provides a data communication connection to the corresponding type of telephone line, which comprises part of network link 1221. If communication interface 1220 is a local area network (LAN) card, communication interface 1220 provides a data communication connection via network link 1221 to a compatible LAN. Wireless links are also possible. In any such implementation, communication interface 1220 sends and receives electrical, electromagnetic or optical signals which carry digital data streams representing various types of information.

Network link 1221 typically provides data communication through one or more networks to other data devices. For example, network link 1221 may provide a connection through local network 1222 to local server computer 1223 or to data equipment operated by ISP 1224. ISP 1224 in turn provides data communication services through the world wide packet data communication network now commonly referred to as the “Internet” 1225. Local network 1222 and Internet 1225 both use electrical electromagnetic or optical signals which carry digital data streams. The signals through the various networks and the signals on network link 1221 and through communication interface 1220, which carry the digital data to and from computer 1201, are exemplary forms of carrier waves transporting the information.

Processor 1213 may reside wholly on client computer 1201 or wholly on server 1226 or processor 1213 may have its computational power distributed between computer 1201 and server 1226. Server 1226 symbolically is represented in FIG. 12 as one unit, but server 1226 can also be distributed between multiple “tiers”. In one embodiment, server 1226 comprises a middle and back tier where application logic executes in the middle tier and persistent data is obtained in the back tier. In the case where processor 1213 resides wholly on server 1226, the results of the computations performed by processor 1213 are transmitted to computer 1201 via Internet 1225, Internet Service Provider (ISP) 1224, local network 1222 and communication interface 1220. In this way, computer 1201 is able to display the results of the computation to a user in the form of output.

Computer 1201 includes a video memory 1214, main memory 1215 and mass storage 1212, all coupled to bi-directional system bus 1218 along with keyboard 1210, mouse 1211 and processor 1213. As with processor 1213, in various computing environments, main memory 1215 and mass storage 1212, can reside wholly on server 1226 or computer 1201, or they may be distributed between the two.

The mass storage 1212 may include both fixed and removable media, such as magnetic, optical or magnetic optical storage systems or any other available mass storage technology. Bus 1218 may contain, for example, thirty-two address lines for addressing video memory 1214 or main memory 1215. The system bus 1218 also includes, for example, a 32-bit data bus for transferring data between and among the components, such as processor 1213, main memory 1215, video memory 1214 and mass storage 1212. Alternatively, multiplex data/address lines may be used instead of separate data and address lines.

In one embodiment of the invention, the microprocessor is manufactured by Intel, such as the 80×86 or Pentium-typed processor. However, any other suitable microprocessor or microcomputer may be utilized. Main memory 1215 is comprised of dynamic random access memory (DRAM). Video memory 1214 is a dual-ported video random access memory. One port of the video memory 1214 is coupled to video amplifier 1216. The video amplifier 1216 is used to drive the cathode ray tube (CRT) raster monitor 1217. Video amplifier 1216 is well known in the art and may be implemented by any suitable apparatus. This circuitry converts pixel data stored in video memory 1214 to a raster signal suitable for use by monitor 1217. Monitor 1217 is a type of monitor suitable for displaying graphic images.

Computer 1201 can send messages and receive data, including program code, through the network(s), network link 1221, and communication interface 1220. In the Internet example, remote server computer 1226 might transmit a requested code for an application program through Internet 1225, ISP 1224, local network 1222 and communication interface 1220. The received code may be executed by processor 1213 as it is received, and/or stored in mass storage 1212, or other non-volatile storage for later execution. In this manner, computer 1201 may obtain application code in the form of a carrier wave. Alternatively, remote server computer 1226 may execute applications using processor 1213, and utilize mass storage 1212, and/or video memory 1215. The results of the execution at server 1226 are then transmitted through Internet 1225, ISP 1224, local network 1222 and communication interface 1220. In this example, computer 1201 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for automated insurance processing is described in conjunction with one or more specific embodiments. The invention is defined by the following claims and their full scope and equivalents.

1. A method for automated insurance processing comprising the steps of:
gathering a first set of information about a potential customer wherein said potential customer is part of a low-margin market;
determining automatically whether a policy is to be automatically offered to said potential customer; and
offering automatically said policy to said potential customer, if said policy is to be automatically issued.

2. The method of claim 1 further comprising the step of:
gathering automatically a second set of information about said potential customer using a first data item in said first set of information.

3. The method of claim 1 or 2 further comprising the steps of:
determining automatically whether said policy is to be automatically denied to said potential customer; and
denying automatically said policy to said potential customer, if said policy is to be automatically denied.

4. The method of claim 3 further comprising the step of:
displaying a third set of information about said potential customer to a policy administrator, if said policy is to be neither automatically offered nor automatically denied.

5. The method of claim 1 wherein said low-margin market is the life insurance middle market.

6. The method of claim 1 further comprising the steps of:
automatically issuing said policy when said policy is automatically offered.

7. A method of automatically determining insurability comprising the steps of:
retrieving automatically a pharmaceutical record for a potential customer wherein said potential customer is part of a low-margin market; and
determining automatically a score for said potential customer based upon said pharmaceutical record.

8. The method of claim 7 wherein said low-margin market is the life insurance middle market.

9. A method of automated insurance processing comprising the steps of:
selecting a set of information wherein said set of information is used in an insurance application and wherein said set of information is gathered slowly, relative to other information used in said insurance application;
gathering said set of information about a potential customer; and
initiating an insurance application process for said potential customer after said step of gathering is complete.

10. The method of claim 9 wherein said potential customer is part of a low-margin market.

11. The method of claim 10 wherein said low-margin market is the life insurance middle market.

12. The method of claim 9 wherein said set of information is medical information.

13. The method of claim 12 wherein said step of gathering is performed in association with a visit wherein the scheduling of said visit was initiated without said potential customer intending to apply for insurance.

14. A method for automated insurance processing comprising the steps of:
retrieving a set of potential customers from a database wherein each of said set of potential customer is part of a low-margin market;
gathering automatically a first set of information from said database about a first potential customer in said set of potential customers;
determining automatically whether a policy is to be automatically offered to said first potential customer; and
offering automatically said policy to said first potential customer, if said policy is to be automatically offered.

15. The method of claim 14 further comprising the step of:
gathering automatically a second set of information about said first potential customer using a first data item in said first set of information.

16. The method of claim 14 or 15 further comprising the steps of:
determining automatically whether said policy is to be automatically denied to said first potential customer; and
denying automatically said policy to said first potential customer, if said policy is to be automatically denied.

17. The method of claim 16 further comprising the step of:
displaying a third set of information about said first potential customer to a policy administrator, if said policy is to be neither automatically offered nor automatically denied.

18. The method of claim 14 wherein said low-margin market is the life insurance middle market.

19. The method of claim 14 further comprising the steps of:
automatically issuing said policy when said policy is automatically offered.

20. An automated insurance processing system comprising:
an information gathering system configured to gather a first set of information about a potential customer wherein said potential customer is part of a low-margin market;
a determiner configured to determine automatically whether a policy is to be automatically offered to said potential customer; and
an offering unit configured to offer automatically said policy to said potential customer, if said policy is to be automatically issued.

21. The automated insurance processing system of claim 20 further comprising:
a second gathering unit configured to gather automatically a second set of information about said potential customer using a first data item in said first set of information.

22. The automated insurance processing system of claim 20 or 21 further comprising:
a second determiner configured to determine automatically whether said policy is to be automatically denied to said potential customer; and
a denying unit configured to deny automatically said policy to said potential customer, if said policy is to be automatically denied.

23. The automated insurance processing system of claim 22 further comprising:
a display unit configured to display a third set of information about said potential customer to a policy administrator, if said policy is to be neither automatically offered nor automatically denied.

24. The automated insurance processing system of claim 20 wherein said low-margin market is the life insurance middle market.

25. The automated insurance processing system of claim 20 further comprising:
an issuing unit configured to automatically issue said policy when said policy is automatically offered.

26. An automated insurance processing system comprising:
a retrieval system configured to retrieve automatically a pharmaceutical record for a potential customer wherein said potential customer is part of a low-margin market; and
a determiner configured to determine automatically a score for said potential customer based upon said pharmaceutical record.

27. The automated insurance processing system of claim 26 wherein said low-margin market is the life insurance middle market.

28. An automated insurance processing system comprising:
a selection unit configured to select a set of information wherein said set of information is used in an insurance application and wherein said set of information is gathered slowly, relative to other information used in said insurance application;
an information gathering system configured to gather said set of information about a potential customer; and
an initiating system configured to initiate an insurance application process for said potential customer after said step of gathering is complete.

29. The automated insurance processing system of claim 28 wherein said potential customer is part of a low-margin market.

30. The automated insurance processing system of claim 29 wherein said low-margin market is the life insurance middle market.

31. The automated insurance processing system of claim 28 wherein said set of information is medical information.

32. The automated insurance processing system of claim 31 wherein said information gathering system is further configured to operate in association with a visit wherein the scheduling of said visit was initiated without said potential customer intending to apply for insurance.

33. An automated insurance processing system comprising:
a retrieval unit configured to retrieve a set of potential customers from a database wherein each of said set of potential customer is part of a low-margin market;
a gathering unit configured to gather automatically a first set of information from said database about a first potential customer in said set of potential customers;
a determiner configured to determine automatically whether a policy is to be automatically offered to said first potential customer; and
an offering system configured to offer automatically said policy to said first potential customer, if said policy is to be automatically offered.

34. The automated insurance processing system of claim 33 further comprising:
a second gathering unit configured to gather automatically a second set of information about said first potential customer using a first data item in said first set of information.

35. The automated insurance processing system of claim 33 or 34 further comprising:
a second determiner configured to determine automatically whether said policy is to be automatically denied to said first potential customer; and
a denying unit configured to deny automatically said policy to said first potential customer, if said policy is to be automatically denied.

36. The automated insurance processing system of claim 35 further comprising:
a display unit configured to display a third set of information about said first potential customer to a policy administrator, if said policy is to be neither automatically offered nor automatically denied.

37. The automated insurance processing system of claim 33 wherein said low-margin market is the life insurance middle market.

38. The automated insurance processing system of claim 33 further comprising:
an issuing unit configured to automatically issue said policy when said policy is automatically offered.

39. An automated insurance processing system comprising:
a means for gathering a first set of information about a potential customer wherein said potential customer is part of a low-margin market;
a means for determining automatically whether a policy is to be automatically offered to said potential customer; and
a means for offering automatically said policy to said potential customer, if said policy is to be automatically issued.

40. The automated insurance processing system of claim 39 further comprising:
a means for gathering automatically a second set of information about said potential customer using a first data item in said first set of information.

41. The automated insurance processing system of claim 39 or 40 further comprising:
a means for determining automatically whether said policy is to be automatically denied to said potential customer; and
a means for denying automatically said policy to said potential customer, if said policy is to be automatically denied.

42. The automated insurance processing system of claim 41 further comprising:
a means for displaying a third set of information about said potential customer to a policy administrator, if said policy is to be neither automatically offered nor automatically denied.

43. The automated insurance processing system of claim 39 wherein said low-margin market is the life insurance middle market.

44. The automated insurance processing system of claim 39 further comprising:
a means for automatically issuing said policy when said policy is automatically offered.

45. An automated insurance processing system comprising:
a means for retrieving automatically a pharmaceutical record for a potential customer wherein said potential customer is part of a low-margin market; and
a means for determining automatically a score for said potential customer based upon said pharmaceutical record.

46. The automated insurance processing system of claim 45 wherein said low-margin market is the life insurance middle market.

47. An automated insurance processing system comprising:
a means for selecting a set of information wherein said set of information is used in an insurance application and wherein said set of information is gathered slowly, relative to other information used in said insurance application;
a means for gathering said set of information about a potential customer; and
a means for initiating an insurance application process for said potential customer after said step of gathering is complete.

48. The automated insurance processing system of claim 47 wherein said potential customer is part of a low-margin market.

49. The automated insurance processing system of claim 48 wherein said low-margin market is the life insurance middle market.

50. The automated insurance processing system of claim 47 wherein said set of information is medical information.

51. The automated insurance processing system of claim 50 wherein said means for gathering is operated in association with a visit wherein the scheduling of said visit was initiated without said potential customer intending to apply for insurance.

52. An automated insurance processing system comprising:
a means for retrieving a set of potential customers from a database wherein each of said set of potential customer is part of a low-margin market;
a means for gathering automatically a first set of information from said database about a first potential customer in said set of potential customers;
a means for determining automatically whether a policy is to be automatically offered to said first potential customer; and
a means for offering automatically said policy to said first potential customer, if said policy is to be automatically offered.

53. The automated insurance processing system of claim 52 further comprising:
a means for gathering automatically a second set of information about said first potential customer using a first data item in said first set of information.

54. The automated insurance processing system of claim 52 or 53 further comprising:
a means for determining automatically whether said policy is to be automatically denied to said first potential customer; and
a means for denying automatically said policy to said first potential customer, if said policy is to be automatically denied.

55. The automated insurance processing system of claim 54 further comprising:
a means for displaying a third set of information about said first potential customer to a policy administrator, if said policy is to be neither automatically offered nor automatically denied.

56. The automated insurance processing system of claim 52 wherein said low-margin market is the life insurance middle market.

57. The automated insurance processing system of claim 52 further comprising:
a means for automatically issuing said policy when said policy is automatically offered.

58. A computer program product comprising:
a computer usable medium having computer readable program code embodied therein configured to automatically process insurance, said computer program product comprising:
computer readable code configured to cause a computer to gather a first set of information about a potential customer wherein said potential customer is part of a low-margin market;
computer readable code configured to cause a computer to determine automatically whether a policy is to be automatically offered to said potential customer; and
computer readable code configured to cause a computer to offer automatically said policy to said potential customer, if said policy is to be automatically issued.

59. The computer program product of claim 58 further comprising:
computer readable code configured to cause a computer to gather automatically a second set of information about said potential customer using a first data item in said first set of information.

60. The computer program product of claim 58 or 59 further comprising:
computer readable code configured to cause a computer to determine automatically whether said policy is to be automatically denied to said potential customer; and
computer readable code configured to cause a computer to deny automatically said policy to said potential customer, if said policy is to be automatically denied.

61. The computer program product of claim 60 further comprising:
computer readable code configured to cause a computer to display a third set of information about said potential customer to a policy administrator, if said policy is to be neither automatically offered nor automatically denied.

62. The computer program product of claim 58 wherein said low-margin market is the life insurance middle market.

63. The computer program product of claim 58 further comprising:
computer readable code configured to cause a computer to automatically issue said policy when said policy is automatically offered.

64. A computer program product comprising:
a computer usable medium having computer readable program code embodied therein configured to automatically process insurance, said computer program product comprising:
computer readable code configured to cause a computer to retrieve automatically a pharmaceutical record for a potential customer wherein said potential customer is part of a low-margin market; and
computer readable code configured to cause a computer to determine automatically a score for said potential customer based upon said pharmaceutical record.

65. The computer program product of claim 64 wherein said low-margin market is the life insurance middle market.

66. A computer program product comprising:
a computer usable medium having computer readable program code embodied therein configured to automatically process insurance, said computer program product comprising:
computer readable code configured to cause a computer to select a set of information wherein said set of information is used in an insurance application and wherein said set of information is gathered slowly, relative to other information used in said insurance application;
computer readable code configured to cause a computer to gather said set of information about a potential customer; and
computer readable code configured to cause a computer to initiate an insurance application process for said potential customer after said step of gathering is complete.

67. The computer program product of claim 66 wherein said potential customer is part of a low-margin market.

68. The computer program product of claim 67 wherein said low-margin market is the life insurance middle market.

69. The computer program product of claim 66 wherein said set of information is medical information.

70. The computer program product of claim 69 wherein said computer readable code configured to cause a computer to gather is further configured to operate in association with a visit wherein the scheduling of said visit was initiated without said potential customer intending to apply for insurance.

71. A computer program product comprising:
a computer usable medium having computer readable program code embodied therein configured to automatically process insurance, said computer program product comprising:
computer readable code configured to cause a computer to retrieve a set of potential customers from a database wherein each of said set of potential customer is part of a low-margin market;
computer readable code configured to cause a computer to gather automatically a first set of information from said database about a first potential customer in said set of potential customers;
computer readable code configured to cause a computer to determine automatically whether a policy is to be automatically offered to said first potential customer; and
computer readable code configured to cause a computer to offer automatically said policy to said first potential customer, if said policy is to be automatically offered.

72. The computer program product of claim 71 further comprising:
computer readable code configured to cause a computer to gather automatically a second set of information about said first potential customer using a first data item in said first set of information.

73. The computer program product of claim 71 or 72 further comprising:
computer readable code configured to cause a computer to determine automatically whether said policy is to be automatically denied to said first potential customer; and
computer readable code configured to cause a computer to deny automatically said policy to said first potential customer, if said policy is to be automatically denied.

74. The computer program product of claim 73 further comprising:
computer readable code configured to cause a computer to display a third set of information about said first potential customer to a policy administrator, if said policy is to be neither automatically offered nor automatically denied.

75. The computer program product of claim 71 wherein said low-margin market is the life insurance middle market.

76. The computer program product of claim 71 further comprising:
computer readable code configured to cause a computer to automatically issue said policy when said policy is automatically offered.
